(19) United States
(12) Patent Application Publication
(10) Pub. No.: US 2021/0256102 A1
(43) Pub. Date: Aug. 19, 2021

(54) REMOTE BIOMETRIC IDENTIFICATION

(71) Applicant: IPCom GmbH & Co. KG, Pullach (DE)

(72) Inventor: Achim Luft, Braunschweig (DE)

(21) Appl. No.: 17/049,283

(22) PCT Filed: Apr. 25, 2019
(86) PCT No.: PCT/EP2019/060593

§ 371 Date: Oct. 20, 2020

(30) Foreign Application Priority Data
Apr. 25, 2018 (EP) 18169287.2

(51) Int. Cl. G06F 21/32; G06F 21/34; H04L 29/06

(52) U.S. Cl. CPC G06F 21/32; G06F 21/34; H04L 63/0876; H04L 63/0861; H04L 63/045

(57) ABSTRACT

The present invention provides a method of operating a device to perform a biometric authentication, the device comprising a biometric authentication unit and a secure element, the method comprising establishing a first secure connection between the biometric authentication unit of the device and the secure element; causing the biometric authentication unit to obtain biometric data from a user of the device and to authenticate said biometric data; transmitting a message from the biometric authentication unit to the secure element containing a result of the authentication over the secure connection; and transmitting the result of the authentication from the secure element to a remote entity over a second secure connection.

The present invention relates to a technique for performing a secure authentication method using biometric data.

Biometric authentication is known as a secure authentication method. A sensor collects biometric data such as the scan of a fingerprint or a retina. A camera capturing a picture of the user's face could be seen as such a sensor as well. The captured data are transferred to a controller chip. The controller performs measurements with the raw data and identifies characteristic features within the raw data. These characteristic features are stored. Each time a user authenticates themselves via a biometric sensor (e.g. a fingerprint sensor) the raw biometric data are transferred from the sensor to the controller. The controller performs the measurement and compares characteristic features with stored features. In case there is a match the user is authenticated within this local system for example a smartphone.

Local biometric authentication cannot be used to authenticate a user remotely from an external server such as an online banking webserver. The biometric authentication can be performed locally but not remote.

A remote biometric authentication would be possible if the characteristic biometric features are stored in a remote location, external of the device. Biometric data are sensitive personal data. Any other credentials could be changed after they have been stolen or revealed, but a user cannot change his biometric characteristics such as a fingerprint.

US 2004/0129787 A1 describes a high security identification card includes an on-board memory for stored biometric data and an on-board sensor for capturing live biometric data. An on-board processor on the card performs a matching operation to verify that the captured biometric data matches the locally stored biometric data. Only if there is a positive match is any data transmitted from the card for additional verification and/or further processing.

WO 2011/091313 A1 describes a technique for trusted identity management in which a biometric authentication function signals success to a trusted visual token, TVT which is a trustworthy entity of the UE such as a UICC. A trusted ticket server of the UE which may communicate with a mobile network operator has a secure channel to the UICC. There is no indication that a secure connection is required between the biometric authentication function and the TVT

US 2016/0344559 A1 describes an arrangement in which a secure channel between one UE and a network entity is used to establish another secure channel between a second UE and the network entity. US 2014/0289833 A1 describes a technique for performing authentication which includes a biometric sensor with an authentication state of the device being provided to a relying party.

The known prior-art overcomes these drawbacks by means of a trusted secure element. This secure element performs the biometric authentication and generates a validation message that is sent over a secure channel. With this a locally performed authentication can be used remotely as secure authentication. This method however contains new drawbacks. The sensor and the trusted secure element have to build a system in which the different components (most likely from different manufacturers) are not balanced and optimized as in a dedicated designed system with harmonized components. Not every sensor will work together with a trusted secure element. Sensor and controller might be built as an inseparable system. If the sensor is connected directly and exclusively to the trusted secure element the sensor cannot be used for different purposes (e.g. unlock a mobile device). If the sensor is not exclusively connected with the trusted secure element sensible biometric data could be intercepted. The sensor might be an element that is used for other purposes such as a microphone which might be used for voice recognition but also for telephone calls.

Also, external biometric devices, such as a Bluetooth fingerprint scanner could not be used in the described prior-art scenario because of a missing secure connection between sensor and controller and because most stand-alone external authentication devices consist of a sensor-controller combination and therefore are not able to export the raw biometric data to a separated controller.

The present invention provides a method of operating a device to perform a biometric authentication, the device comprising a biometric authentication unit and a secure element, the method comprising establishing a first secure connection between the biometric authentication unit of the device and the secure element; causing the biometric authentication unit to obtain biometric data from a user of the device and to authenticate said biometric data; transmitting a message from the biometric authentication unit to the secure element containing a result of the authentication over the secure connection; and transmitting the result of the authentication from the secure element to a remote entity over a second secure connection.

The invention may be used to establish a secure connection between a certified biometric authentication device and a secure element in order to perform a secure remote biometric authentication. The secure connection could be established by symmetric cryptography: If a biometric device passes a certification process a shared secret (e.g. 256-bit AES key) is injected into the controller and the trusted secure element (e.g. a Universal Integrated Circuit Card, UICC) in order to establish a cyphered connection between the controller and the secure element. Another way is to base the secure connection on asymmetric cryptography. If a biometric authentication device passes the certification process, a certificate (signed by a certification authority) is generated and stored in the device. The device could present the certificate to the trusted secure element (e.g. UICC), the secure element is able to validate the certificate with the public key of the certification authority and is able to use the public key of the biometric device to either share a session key for a symmetric secure connection or in order to verify a signed message generated by the authentication device.

A remote entity (e.g. a mobile phone network operator) is able to trigger a remote biometric authentication of the user by sending a “user authentication” message to the trusted secure element via the pre-established secure connection (pre-shared secret) to the secure element. The secure element establishes a secure connection to the biometric authentication device and triggers the user authentication either directly or via the operating system of a host device (e.g. a smartphone). The biometric authentication device performs the authentication and sends the result of the authentication either via a secure connection directly to the secure element or digitally signs the message with the result and sends the message via the operating system of the host device to the secure element. The secure element forwards the result to the remote entity.

Preferred embodiments of the invention will now be described, by way of example only, with reference to the accompanying drawings in which:

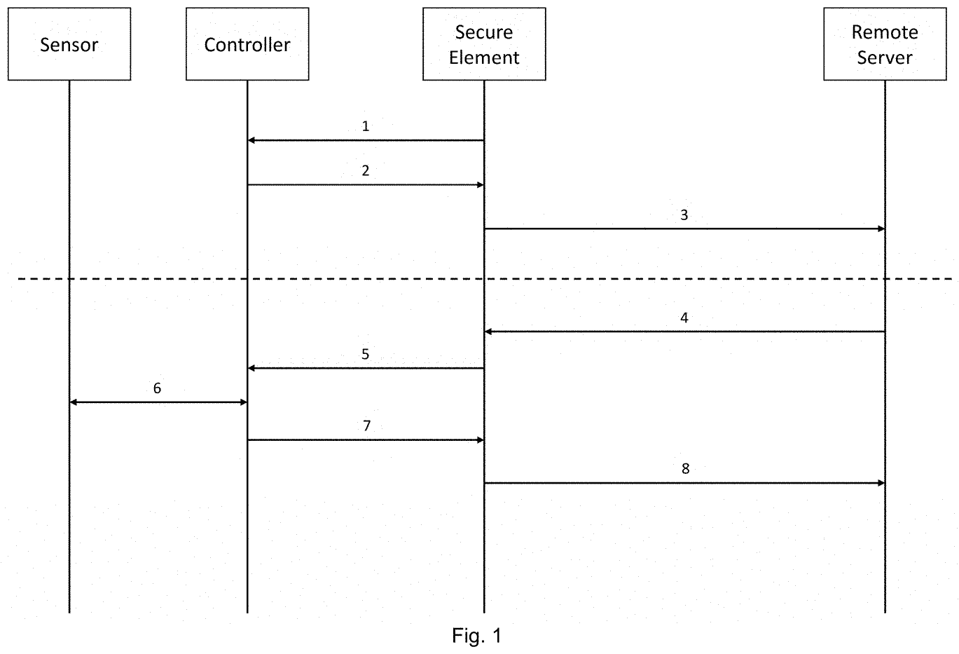

FIG. 1 is a message flow for an authentication procedure using symmetric encryption;

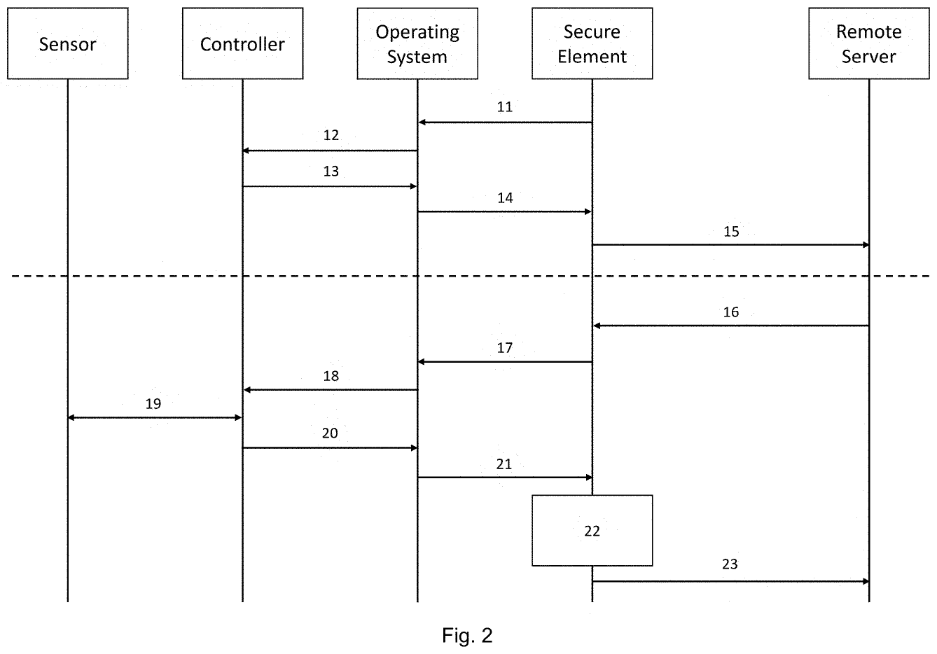

FIG. 2 is a message flow for an authentication procedure using asymmetric encryption;

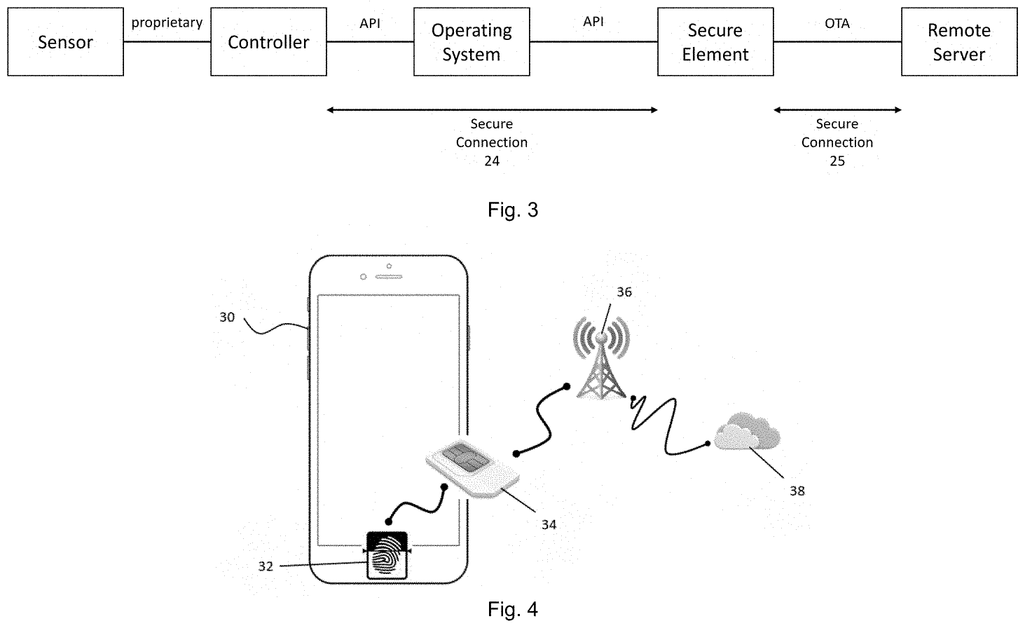

FIG. 3 shows a schematic representation of components involved in the authentication process; and

FIG. 4 is a schematic representation of the use of a smartphone to perform an authentication.

FIG. 4 shows a schematic representation of the invention in which a smartphone 30 is used for biometric authentication. The smartphone includes a biometric sensor, in this case a finger print sensor 32. Inserted, or programmed, into the smartphone is a SIM card 34 forming a secure element. The smartphone is in communication with a base station 36 and hence a remote server 38.

Symmetric cryptography is illustrated in FIG. 1 and asymmetric cryptography is illustrated in FIG. 2.

FIG. 1 illustrates a message flow of a scenario, in which a secure element and a controller of the biometric authentication device are communicating directly via a symmetric ciphered and/or integrity protected connection.

A pre-condition of this scenario is a secure connection between a remote server and the secure element. The operator of the remote server has certified the biometric authentication device and a shared secret (e.g. 256-bit AES key) is stored in the secure element and the controller of the authentication device.

FIG. 1 shows eight messages as follows.

Message 1: MSG1 device registration: This message establishes a secure connection between the secure element and the controller of the authentication device. It may contain a key ID to identify the shared secret that should be used for this connection. It might also contain a challenge (e.g. a nonce) to prevent a replay attack.

Message 2: MSG2 Auth RES: This message is the response to MSG1 and is using the shared secret. It may contain the response to the challenge of MSG1.

Message 3: MSG3 capability message: This message is to inform the remote server about existence of compliant authentication devices and their capabilities.

Message 4: MSG4 trigger: This message triggers a biometric authentication of the user.

Message 5: MSG5 trigger: The secure element forwards MSG4 to the controller. A translation between two different protocols may have to be performed.

Message 6: Raw data communication between controller and sensor.

Message 7: MSG6 result: This message contains the result of the biometric authentication.

Message 8: MSG7 result: The result of the authentication is forwarded to the remote server using a symmetric secure connection. A translation between two different protocols may have to be performed.

FIG. 2 illustrates a message flow of a scenario, in which the secure element and the controller of the biometric authentication device are communicating via an operating system of a host device (e.g. smartphone). The operating system may offer standardized application programming interfaces (APIs) to allow the secure element to communicate with the controller of the authentication device. The connection is secured with asymmetric cryptography.

A pre-condition of this scenario is a secure connection between the remote server and the secure element. The operator of the remote server has certified the biometric authentication device and a certificate is stored in the controller. The certificate is signed by a certificate authorization that is trusted by the operator of the remote server. The certificate contains a public key out of a key pair (public and private key).

FIG. 2 shows thirteen messages and steps as follows:

Message 11: MSG11 device registration: This message establishes a secure connection between the secure element and the controller of the authentication device via the Operating System.

Message 12: MSG12 device registration: The operating system forwards MSG11 to the controller of the authentication device. A translation between two different protocols may have to be performed.

Message 13: MSG13 Auth RES: This message is the response to MSG12 and contains the authentication device's certificate.

Message 14: MSG14 Auth RES: The operating system forwards MSG13 to the secure element. A translation between two different protocols may have to be performed.

Message 15: MSG15 capability message: This message informs the remote server about existence of compliant authentication devices and their capabilities.

Message 16: MSG16 trigger: This message triggers a biometric authentication of the user.

Message 17: MSG17 trigger: The secure element forwards MSG16 to the operating system. A translation between two different protocols may have to be performed.

Message 18: MSG18 trigger: The operating system forwards MSG17 to the controller of the authentication device. A translation between two different protocols may have to be performed.

Message 19: Raw data communication between controller and sensor.

Message 20: MSG19 result: This message contains the result of the biometric authentication. The result is signed with the private key of the authentication device.

Message 21: MSG20 result: The operating system forwards MSG19 to the secure element. A translation between two different protocols may have to be performed.

Step 22: The secure element verifies the digital signature of the result of the authentication with use of the public key of the authentication device. This public key is extracted from the certificate.

Message 23: MSG21 result: The result of the authentication is forwarded to the remote server using a symmetric secure connection. A translation between two different protocols may have to be performed. In case the digital signature of the result could not be verified or the integrity protection fails in another way, MSG21 contains a corresponding error code.

It is beneficial to setup a steady association between an authenticated user of the terminal and the subscription in the operator's SIM. To prevent other users than the subscriber to establish an authentication between user and subscriber the PIN or PUK of the subscription might be requested. It is also possible that the operator authorizes the binding. The operator might want the subscriber to come in person to a local store or trusted service point in order to verify himself as the subscriber. For subscribers' convenience the operator also could offer a web-based service in which the process of binding is executed and is authorized remotely over the air.

Once the association between main user of the device and subscription in the SIM is established, the biometric authentication can be used to unlock the SIM or for additional operator's services such as Multi-SIM activation, using the service hotline, order new smartphone, or extent the contract. Since in the database of the operator the personal data of a subscriber is stored, the operator also knows the person behind the subscription and the main user of the device.

For the user, new features can be enabled that increases user convenience significantly. For example, biometric SIM activation, i.e. without necessity to enter a PIN, and biometric authentication for service calls, i.e. without the necessity to remember a password or exchange personal information, may be enabled.

One possible embodiment of the asymmetric scenario will now be described in detail. Even though in the asymmetric scenario the secure connection between the secure element and the remote server is most likely symmetric. This is because symmetric cryptography is less complex, faster and quantum computer proof. The problem that asymmetric cryptography might be broken in the future because of future development of high performance quantum computers is also the reason why there shouldn't be an asymmetric secured connection directly from the sensor/controller to the remote server. Symmetric cryptography with appropriate key length on the other hand is presumed to be resistant to decryption with quantum computers.

The following describes an embodiment of the pre-conditions of this scenario. An operator has deployed SIM cards to all his subscribers. Each SIM card and the database of the operator's network share a 256-bit symmetric long-term key. This long-term key K is used to establish a secure connection between the network elements and the SIM card. The SIM card in this embodiment is the secure element. The operator has protocols established to securely communicate with the secure element. This connection is confidentiality and integrity protected. The operator assigns a third party to certify a smartphone vendor via an audit to ensure that a specific smartphone model has a trustworthy fingerprint scanner implemented. The smartphone vendor generates an asymmetric key pair and generates a certificate request. The request is sent to the operator. With positive certification, the operator generates a certificate for this smartphone model. The certificate and the asymmetric key pair are stored in the fingerprint scanner.

The following describes the setup of the inventive remote biometric authentication. The subscriber inserts his SIM card into his smartphone. The smartphone model has been certified by the operator to enable remote biometric authentications. During the initialization procedure of the inserted SIM card, the SIM card generates MSG11 and sends the message via a standardized API to the operating system. MSG11 contains the certificate authority (CA). The operating system of the smartphone (e.g. android or iOS) forwards the content of MSG11 via a propriety interface in MSG12 to the controller of the in the smartphone implemented fingerprint scanner. The controller verifies whether one of the stored certificates is signed by the in MSG11 indicated CA. If there is a match the corresponding certificate is attached to MSG13 to the operating system of the smartphone. The operating system forwards the content of MSG13 (including the certificate) in MSG14 via the API to the SIM card. In case an error occurs in these steps, MSG14 might contain an error code. An example of such an error might be “No certificate available”. The SIM card validates the certificate with the pre-installed public key of the CA. If the certificate is valid the SIM card is able to establish a secure connection between the SIM card and the controller of the fingerprint scanner and to validate any digitally signed messages from the controller of the fingerprint scanner. In order to establish a secure connection, the SIM card could generate a symmetric session key for this connection and encrypt it with the public key of the controller, send the encrypted key to controller and the controller is able to decrypt the session key with the private key of the controller's key pair. Both the controller and the SIM card share a symmetric session key that can be used for cyphering or integrity protect the messages between these two entities.

If the home operator or a third party via the home operator wants to authenticate the user of the phone with the implemented fingerprint scanner, the operator sends an authentication request through the secure connection between the operator network and the SIM card. The home operator is able to offer an external API to third parties. For example, a bank could request a biometric authentication of an online banking customer via such an API of the home operator. The operator forwards the request to the SIM card inserted in the smartphone and forwards also the response back to the bank. In this embodiment, the request is sent via the OTA protocol (as specified by the open mobile alliance) as a binary short message. It is beneficial that the request contains a nonce (a random number used as a one-time password) or a timestamp as protection against replay attacks. The SIM card translates the request into a corresponding API authentication request adding the nonce if available. The operating system forwards the request to the controller of the fingerprint scanner and prompts the user to authenticate himself with his stored fingerprint. The user lays a finger on the fingerprint scanner. The sensor scans the fingerprint and forwards the biometric data to the controller. The controller compares the characteristic features of the fingerprint with securely stored data. If the fingerprint matches any stored data, the controller generates a response to the authentication request, adds the nonce or timestamp from the request to the response and digitally signs the complete response with the private key of the own key-pair. The response is send via the operating system of the phone to the SIM card. The SIM card verifies the digital signature with the public key of the controller of the fingerprint scanner. The message could optionally be encrypted or be sent via an encrypted connection between the controller and the SIM card. On the other hand, there is no sensitive information in the response. It is important, that the response is not altered by an attacker and that it is not the replay of a former response. The inclusion of a nonce or a timestamp and the integrity protection mitigates these threats. The sensitive biometric user data are not leaving the fingerprint scanner at any time. If the signature is valid the SIM card forwards the response via OTA to the operator and the operator via his API to the requesting third party. The mobile operator could charge the bank for this new service.

In a further example, a remote biometric authentication is requested by third-party service provider for two-factor authentication to web-based service.

A social media network could offer a secure two-factor biometric authentication to its users. A registered user can switch-on two-factor authentication and add his phone number (MSISDN) to his profile. The phone number could be verified once by sending a code in a short message to the phone number and request verification of the phone number from the user by entering the transmitted code. Once the correct phone number is stored in the user's profile in the social media network, each time the user logs in to the service with username and password, the social media network as a third-party service sends an authentication request to the user's mobile phone operator, e.g. by using an API of this operator. The operator sends a biometric authentication request to the secure element (e.g. by hidden short message or by any other OTA communication with the UICC). The secure element sends a request for authentication of the subscriber to the secure authentication controller of the terminal. The controller executes the biometric authentication. In this procedure the user of the terminal is prompted to authenticate himself as subscriber. In this prompt the requestor and the reason for this authentication procedure (e.g. login to <social media network> from <geo location> at <timestamp>) should be displayed to the user.

After the authentication process is executed, the controller sends the result of the authentication in a digitally signed message to the secure element. The secure element verifies the signature using the stored public key of the operator and sends a new message with the same result via a secure channel to the operator's network. The operator sends the result of the authentication procedure back to the third-party service provider (e.g. using the same API as used for the request). This operator-authenticated two-factor authentication is secure even if the terminal has been stolen or is in use by another user than the subscriber, because of the biometric authentication of the subscriber.

The invention may be summarised as follows:

A remote biometric authentication method via two concatenated secure connections is provided: a first secure connection 24 between secure element and a stakeholder of the secure element for example a SIM card and a home operator via symmetric cryptography (shared key) and a second secure connection 25 between a controller of a biometric authentication device (e.g. fingerprint scanner) and the secure element with a remote stakeholder, e.g. a SIM card via symmetric or asymmetric cryptography, as illustrated in FIG. 3.

Another scenario would be a laptop with an integrated trusted platform module, TPM, and a fingerprint scanner. An employing company would be a stakeholder of the TPM in their employee's laptop and might want to perform a remote biometric authentication of the employee before establishing a VPN to the company's network. Accordingly, the invention is not restricted to a situation of a home operator and a SIM card.

The invention enables the home operator of a mobile network to offer a new “remote biometric authentication” service via an API to third parties.

The invention provides a novel “remote biometric authentication request” with replay attack protection via secure connection between home operator and SIM card (e.g. via OMA OTA).

The invention enables the smartphone vendor to offer an operation system wide API to trigger a biometric authentication.

The operator can offer biometric authentication to the subscriber in order to unlock the SIM card, activate new multi-SIM-cards, authenticate himself in calls to technical service, purchase a new phone, or extend the mobile phone contract.

The invention provides a method that includes secure storage of sensitive biometric user data, integrity protection and replay attack protection of authentication response, future proof symmetric cryptography between operator and smartphone via SIM card.

The invention provides the following advantages.

There exist several advantages of the remote biometric authentication service over an application-based solution for all involved stakeholders.

For a mobile phone network operator, the main advantage is that they are enabled to define requirements for the hardware and software implementation. The operator can require a certain specified assurance level for the biometric authentication implementation comprised of one or more biometric sensors (e.g. fingerprint sensor, face recognition, voice recognition, iris scanner, etc.) and a secure controller operating the sensors and securely store and process biometric related data. In order to participate in a remote biometric authentication service of an operator every mobile device manufacturer needs the operator to digitally sign the certificate of the implemented biometric authentication controller. The signature can be revoked at any time. So, mobile operators have full control of what implementation is allowed to participate in this service. An operator is able to ensure that only trusted implementations are part of their service. Additionally, operator can bind the biometric authentication either to a subscription or to a natural person behind the subscription. The operator owned UICC is bound to exactly one subscription. Therefore, the local user authentication can be bound e.g. via SIM authentication (PIN/PUK) to the subscriber. Although it is in the interest of the user not to bind other than his own biometric user authentication to the SIM, operators are easily able to oversee the binding. An operator can request a user to visit a local store or trusted service point to bind the user authentication to the subscription in front of an employee. Also, a third party web based service can be used to ensure correct binding between local user authentication and remote subscriber authentication via the UICC. User authentication is already a requirement in later mobile network specification releases and might become subject to local regulatory requirements also. Once established, an operator can use the service for own purposes but also offer a remote biometric authentication service to third party service providers.

By means of the invention, a third-party service provider such as the subscriber's online banking service can order the remote biometric authentication service offered by the user's operator. Biometric authentication is more secure than username and password, more convenient for the user and bound to the subscription and therefore finally to the person behind the subscription. The service may offer a sufficient assurance level and third parties don't have to develop applications dedicated to their service. There is no need to trust application developers.

Using the invention, the user is able to use a convenient and secure biometric authentication. The authentication is a native part of the operating system of the personal user device. There is no need for the user to install and rely on more or less trusted third-party applications. There is no need to store sensible security credentials in an application that might become target for attackers. Also, important advantage for the user over application-based solutions is the far better user experience. Once the biometric user authentication is bound to the user as person or to the subscription, it can be used without any further user interaction for many different services without revealing any personal information about him except that he is the legitimate user of his personal device.

1. A method of operating a device to perform a biometric authentication, the device comprising a biometric authentication unit and a secure element, the method comprising:
establishing a first secure connection between the biometric authentication unit of the device and the secure element;
causing the biometric authentication unit to obtain biometric data from a user of the device and to authenticate said biometric data;
transmitting a message from the biometric authentication unit to the secure element containing a result of the authentication over the secure connection; and
transmitting the result of the authentication from the secure element to a remote entity over a second secure connection.

2. The method according to claim 1, wherein the biometric authentication unit is provided with a certification either by or on behalf of the remote entity prior to the authentication process.

3. The method according to claim 1, wherein the secure element is a universal integrated circuit card, preferably a subscriber identity module, SIM, or a universal subscriber identity module.

4. The method according to claim 1, wherein the secure element validates a certificate of the biometric authentication unit prior to transmitting the result of the authentication to the remote entity.

5. The method according to claim 1, wherein the first secure connection is provided using symmetric encryption.

6. The method according to claim 1, wherein the first secure connection is provided using asymmetric encryption.

7. The method according to claim 1, wherein the biometric authentication is performed in response to a request received by the secure element from an external source.

8. The method according to claim 1, wherein the biometric authentication unit includes a controller and a sensor.
